(19) United States
(12) Patent Application Publication
(10) Pub. No.: US 2012/0204008 A1
(43) Pub. Date: Aug. 9, 2012

(54) Processor with a Hybrid Instruction Queue with Instruction Elaboration Between Sections

(75) Inventors: Kenneth Alan Dockser, Cary, NC (US); Yusuf Cagatay Tekmen, Raleigh, NC (US)

(73) Assignee: QUALCOMM INCORPORATED, San Diego, CA (US)

(21) Appl. No.: 13/363,555

(22) Filed: Feb. 1, 2012

Related U.S. Application Data
(60) Provisional application No. 61/439,770, filed on Feb. 4, 2011.

(51) Int. Cl. G06F 9/312; G06F 9/38

(52) U.S. Cl. 712/208; 712/226; 712/214; 712/E09.028; 712/E09.033; 712/E09.049; 712/E09.021

(57) ABSTRACT

Methods and apparatus for processing instructions by elaboration of instructions prior to issuing the instructions for execution are described. An instruction is received at a hybrid instruction queue comprised of a first queue and a second queue. When the second queue has available space, the instruction is elaborated to expand one or more bit fields to reduce decoding complexity when the elaborated instruction is issued, wherein the elaborated instruction is stored in the second queue. When the second queue does not have available space, the instruction is stored in an unelaborated form in a first queue. The first queue is configured as an exemplary in-order queue and the second queue is configured as an exemplary out-of-order queue.

The present Application for Patent claims priority to Provisional Application No. 61/439,770 entitled “Processor with a Hybrid Instruction Queue with Instruction Elaboration between Sections” filed Feb. 4, 2011, and assigned to the assignee hereof and hereby expressly incorporated by reference herein.

### FIELD OF THE INVENTION

The present invention relates generally to techniques for organizing and managing an instruction queue in a processing system and, more specifically, to techniques for a hybrid instruction queue with instruction elaboration between sections.

### BACKGROUND OF THE INVENTION

Many portable products, such as cell phones, laptop computers, personal digital assistants (PDAs) or the like, incorporate one or more processors executing programs that support communication and multimedia applications. The processors need to operate with high performance and efficiency to support the plurality of computationally intensive functions for such products.

The processors operate by fetching instructions from a unified instruction fetch queue which is generally coupled to an instruction cache. There is often a need to have a sufficiently large in-order unified instruction fetch queue supporting the processors to allow for the evaluation of the instructions for efficient dispatching. For example, in a system having two or more processors that share a unified instruction fetch queue, one of the processors may be a coprocessor. In such a system, it is often necessary to have a coprocessor instruction queue downstream from the unified instruction fetch queue. This downstream queue should be sufficiently large to minimize backpressure on processor instructions in the instruction fetch queue to reduce the effect of coprocessor instructions on the performance of the processor. Often it is desirable to do a preliminary decode, a predecode, on instruction opcodes in early stages of processing in order to facilitate efficient opcode decoding in later pipeline stages. The predecode process generally increases the information content to be stored with the instruction. Thus, the predecode process is generally limited to minimize the effect of the additional information content has on storage, such as instruction queues, and on power utilization.

### SUMMARY

Among its several aspects, the present invention recognizes a need for improved instruction queues in a multiple processor system. To such ends, an embodiment of the invention addresses a method for processing instructions. Instructions are received at a hybrid instruction queue. If an out-of-order portion of the hybrid instruction queue has available space, the instructions are elaborated and the elaborated instructions are stored in the out-of-order portion. If the out-of-order portion does not have available space, the instructions are stored in unelaborated form in a first queue.

Another embodiment of the invention applies an apparatus for processing instructions. An elaborate circuit is configured to recode instructions accessed from an instruction queue to form elaborated instructions. An issue queue is configured to store the elaborated instructions from which the elaborated instructions are issued to a coupled execution pipeline.

Another embodiment of the invention addresses a method for processing instructions. An instruction is received at a hybrid instruction queue comprised of a first queue and a second queue. When the second queue has available space, the instruction is elaborated to expand one or more bit fields to reduce decoding complexity when the elaborated instruction is issued, wherein the elaborated instruction is stored in the second queue. When the second queue does not have available space, the instruction is stored in an unelaborated form in a first queue.

Another embodiment of the invention addresses a method for processing instructions. Means for receiving instructions at a hybrid instruction queue, wherein the hybrid instruction queue comprises a first queue and an out-of-order queue. Means for elaborating the instructions and storing the elaborated instructions in the out-of-order queue if space is available in the out-of-order queue. Means for storing the instructions in unelaborated form in a first queue if space is not available in the out-of-order queue.

Another embodiment of the invention addresses a computer readable non-transitory medium encoded with computer readable program data and code when executed operate a system. Receive an instruction at a hybrid instruction queue comprised of a first queue and a second queue. When the second queue has available space, elaborate the instruction to expand one or more bit fields to reduce decoding complexity when the elaborated instruction is issued, wherein the elaborated instruction is stored in the second queue. When the second queue does not have available space, store the instruction in unelaborated form in a first queue.

It is understood that other embodiments of the present invention will become readily apparent to those skilled in the art from the following detailed description, wherein various embodiments of the invention are shown and described by way of illustration. It will be realized that the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1 is a block diagram of an exemplary wireless communication system in which an embodiment of the invention may be advantageously employed;

FIG. 2A illustrates a processor complex with a memory hierarchy, processor, and a coprocessor in accordance with an embodiment of the present invention;

FIG. 2B illustrates an encoded format of a generic native instruction;

FIG. 2C illustrates an elaborated format of the generic native instruction of FIG. 2B in accordance with an embodiment of the present invention;

FIG. 3 illustrates a process for instruction elaboration in accordance with an embodiment of the present invention; and

FIG. 4 illustrates an exemplary embodiment of a coprocessor and processor interface in accordance with an embodiment of the present invention.

### DETAILED DESCRIPTION

The present invention will now be described more fully with reference to the accompanying drawings, in which several embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

Computer program code or “program code” for being operated upon or for carrying out operations according to the teachings of the invention may be initially written in a high level programming language such as C, C++, JAVA®, Smalltalk, JavaScript®, Visual Basic®, TSQL, Perl, or in various other programming languages. A program written in one of these languages is compiled to a target processor architecture by converting the high level program code into a native assembler program. Programs for the target processor architecture may also be written directly in the native assembler language. A native assembler program uses instruction mnemonic representations of machine level binary instructions specified in a native instruction format, such as a 32-bit native instruction format. Program code or computer readable medium as used herein refers to machine language code such as object code whose format is understandable by a processor.

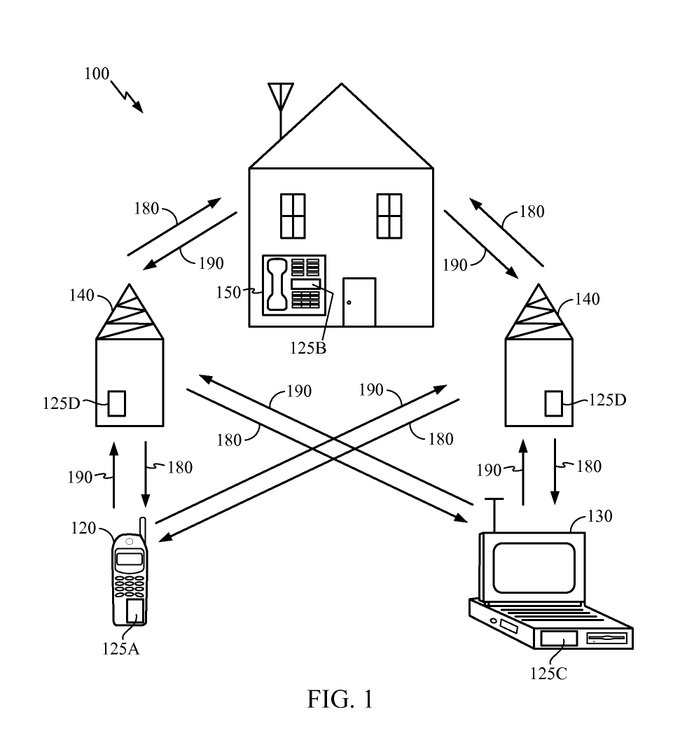

FIG. 1 illustrates an exemplary wireless communication system 100 in which an embodiment of the invention may be advantageously employed. For purposes of illustration, FIG. 1 shows three remote units 120, 130, and 150 and two base stations 140. It will be recognized that common wireless communication systems may have many more remote units and base stations. Remote units 120, 130, 150, and base stations 140 which include hardware components, software components, or both as represented by components 125A, 125C, 125B, and 125D, respectively, have been adapted to embody the invention as discussed further below.

FIG. 1 shows forward link signals 180 from the base stations 140 to the remote units 120, 130, and 150 and reverse link signals 190 from the remote units 120, 130, and 150 to the base stations 140.

In FIG. 1, remote unit 120 is shown as a mobile telephone, remote unit 130 is shown as a portable computer, and remote unit 150 is shown as a fixed location remote unit in a wireless local loop system. By way of example, the remote units may alternatively be cell phones, pagers, walkie talkies, handheld personal communication system (PCS) units, portable data units such as personal digital assistants, or fixed location data units such as meter reading equipment. Although FIG. 1 illustrates remote units according to the teachings of the disclosure, the disclosure is not limited to these exemplary illustrated units. Embodiments of the invention may be suitably employed in any processor system having a two or more processors sharing an instruction queue.

In a system having two or more processors that share an instruction fetch queue, one of the processors may be a coprocessor, such as a vector processor, a single instruction multiple data (SIMD) processor, or the like. In such a system, the capacity of the instruction fetch queue may be increased to minimize backpressure on processor instructions reducing the effect of coprocessor instructions in the instruction fetch queue on the performance of the processor. In order to improve on the performance of the coprocessor, the coprocessor is configured to process coprocessor instructions not having dependencies in an out-of-order sequence. Large queues may be cost prohibitive in terms of power use, implementation area, and impact to timing and performance to provide the support needed for tracking the program order of the instructions in the queue.

Queues may be implemented as in-order queues or out-of-order (OoO) queues. In-order instruction queues are basically first-in first-out (FIFO) queues that are configured to enforce a strict ordering of instructions. The first instructions that are stored in a FIFO queue are the first instructions that are read out, thereby tracking instructions in program order. In many cases, instructions that do not have dependencies can execute out of order, but the strict FIFO order prevents executable out-of-order instructions from being executed. An out-of-order instruction queue, as used herein, is configured to write instructions in-order and to access instructions out-of-order. Such OoO instruction queues are more complex as they require an additional means of tracking program order and dependencies between instructions, since instructions in the queue may be accessed in a different order than they were entered. Also, the larger an OoO instruction queue becomes, the more expensive the tracking means becomes.

A processor complex instruction queue of the present invention consists of a combination of a processor instruction fetch queue and a coprocessor instruction queue. The processor instruction fetch queue is configured as a FIFO in-order instruction queue and stores a plurality of processor instructions and coprocessor instructions according to a program ordering of instructions. The coprocessor instruction queue is configured as a hybrid queue comprising an in-order FIFO queue and an out-of-order queue. The coprocessor instruction queue is coupled to the processor instruction fetch queue, from which coprocessor instructions are accessed out-of-order with respect to processor instructions and accessed in-order with respect to coprocessor instructions.

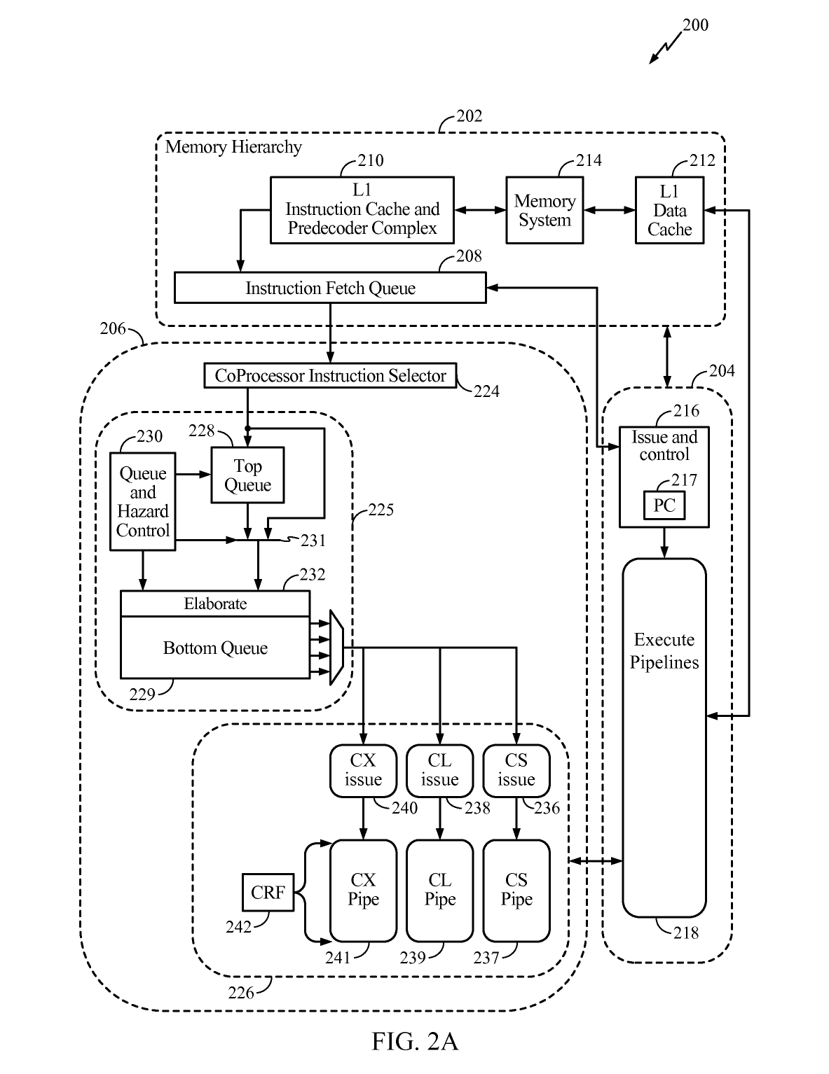

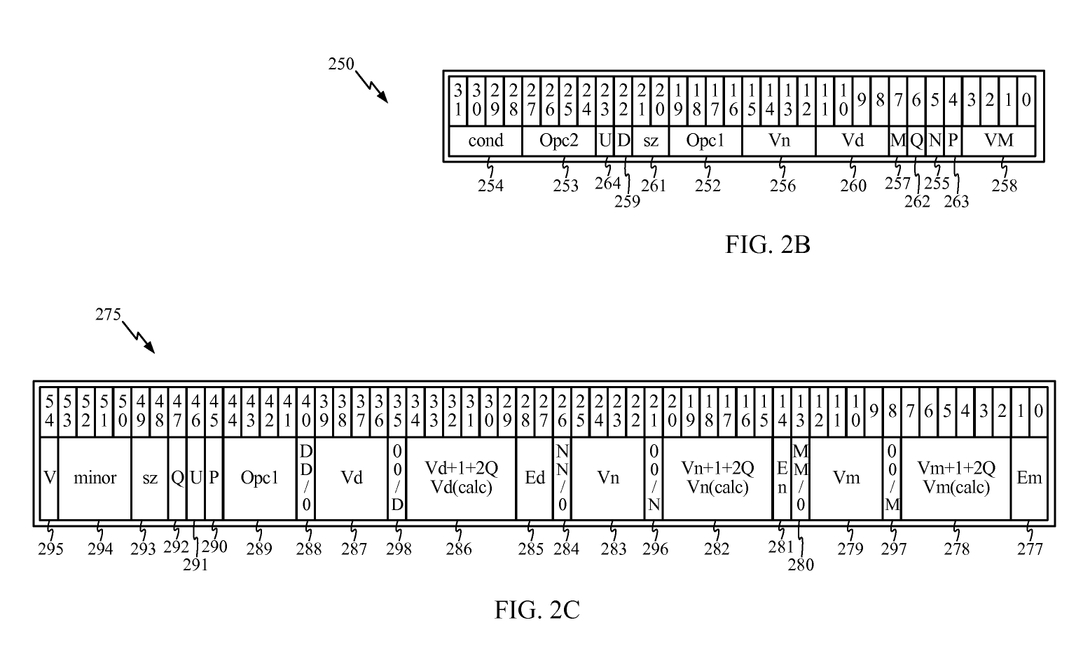

FIG. 2A illustrates a processor complex 200 with a memory hierarchy 202, processor 204, and a coprocessor 206 in accordance with the present invention. The memory hierarchy 202 includes an instruction fetch queue 208, a level 1 instruction cache (L1 I-cache) and predecoder complex 210, a level 1 data cache (L1 D-cache) 212, and a memory system 214. While the instruction fetch queue 208 is shown in the memory hierarchy 202 it may also be suitably located in the processor 204 or in the coprocessor 206. Peripheral devices which may connect to the processor complex are not shown for clarity of discussion. The processor complex 200 may be suitably employed in hardware components 125A-125D of FIG. 1 for executing program code that is stored in the L1 I-cache 210, utilizing data stored in the L1 D-cache 212 and associated with the memory system 214, which may include higher levels of cache and main memory. The processor 204 may be a general purpose processor, a multi-threaded processor, a digital signal processor (DSP), an application specific processor (ASP) or the like. The coprocessor 206 may be a general purpose processor, a digital signal processor, a vector processor, a single instruction multiple data (SIMD) processor, an application specific coprocessor or the like. The various components of the processing complex 200 may be implemented using application specific integrated circuit (ASIC) technology, field programmable gate array (FPGA) technology, or other programmable logic, discrete gate or transistor logic, or any other available technology suitable for an intended application.

The processor 204 includes, for example, an issue and control circuit 216 having a program counter (PC) 217 and execution pipelines 218. The issue and control circuit 216 fetches a packet of, for example, four instructions from the L1 I-cache 210 according to the program order of instructions from the instruction fetch queue 208 for processing by later execute pipelines 218. If an instruction fetch operation misses in the L1 I-cache 210, the instruction is fetched from the memory system 214 which may include multiple levels of cache, such as a level 2 (L2) cache, and main memory. It is appreciated that the four instructions in the packet are decoded and issued to the execution pipelines 218 in parallel. Since architecturally a packet is not limited to four instructions, more or less than four instructions may be issued and executed in parallel depending on an implementation and an application's requirements.

The processor complex 200 may be configured to execute instructions under control of a program stored on a computer readable storage medium. For example, a computer readable storage medium may be either directly associated locally with the processor complex 200, such as may be available from the L1 I-cache 210, for operation on data obtained from the L1 D-cache 212, and the memory system 214. A program comprising a sequence of instructions may be loaded to the memory hierarchy 202 from other sources, such as a boot read only memory (ROM), a hard drive, an optical disk, or from an external interface, such as a network.

The coprocessor 206 includes, for example, a coprocessor instruction selector 224, a hybrid instruction queue 225, and a coprocessor execution complex 226. The hybrid instruction queue 225 is coupled to the instruction fetch queue 208 by means of the coprocessor instruction selector 224. Coprocessor instructions are selected from the instruction fetch queue 208 out-of-order with respect to processor instructions and in-order with respect to coprocessor instructions. The coprocessor instruction selector 224 has access to a plurality of instructions in the instruction fetch queue 208 and is able to identify coprocessor instructions within the plurality of instructions it has access to for selection. The coprocessor instruction selector 224 copies coprocessor instructions from the instruction fetch queue 208 and provides the copied coprocessor instructions to the hybrid instruction queue 225.

An instruction may be recoded into a format where the location of certain bit fields may be rearranged, different bit fields may be decoded, and the number of bits comprising the instruction format may be changed, considered an elaboration of the instruction, prior to being issued to a coprocessor execution pipeline in order to facilitate efficient decoding and hazard detection. The elaborated instructions are in many cases larger than unelaborated instructions. The number of elaborated coprocessor instructions that can be stored in a coprocessor instruction queue may be practically limited due to the size of the elaboration and the consequent impact on power in a particular implementation technology. However, it is also desirable to have a coprocessor queue large enough to minimize backpressure on an issue queue of the main processor.

The hybrid instruction queue 225 comprises a top queue 228, such as an in-order FIFO queue, an elaborate circuit 232, and a bottom queue 229, such as an out-of-order (OoO) queue with a queue and hazard control circuit 230 configured to manage both queues. Thus the hybrid instruction queue 225 is a segmented queue. It is noted that there is no requirement that the second queue be an OoO queue for the elaboration process to operate. The second queue may be another FIFO queue or other type of queue utilized for a particular implementation. In accordance with the present invention, a coprocessor instruction elaboration occurs between the two queues.

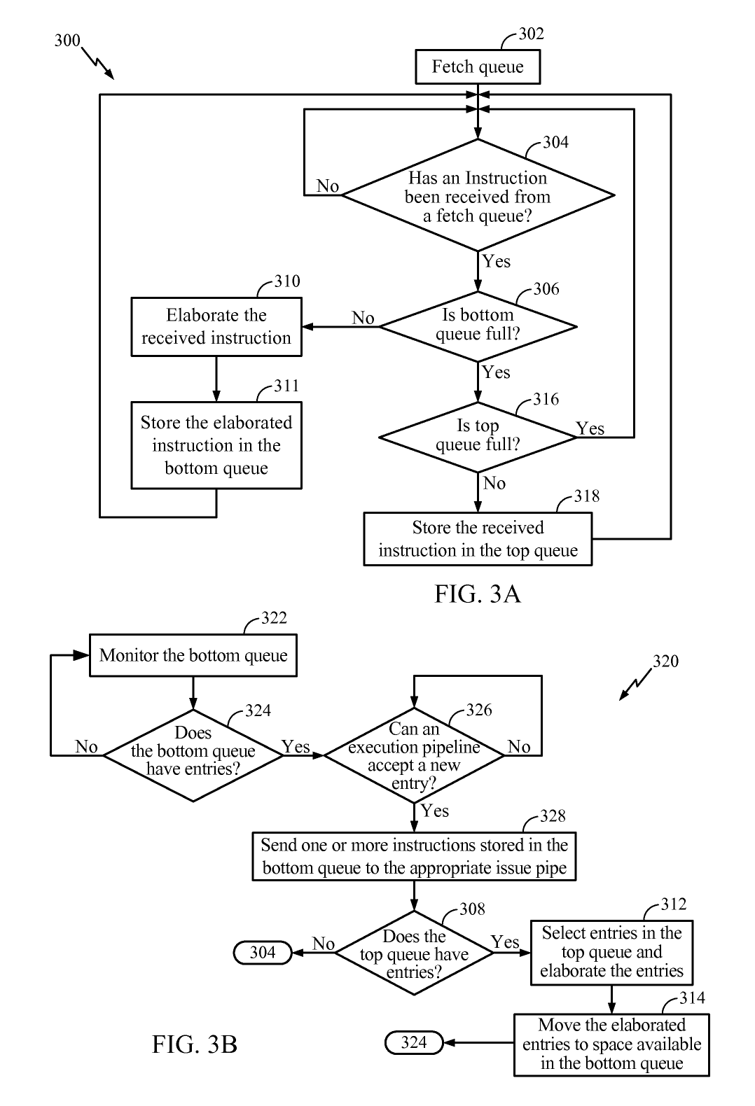

In the hybrid instruction queue 225, when instructions arrive as accessed from the instruction fetch queue 208, a determination is made whether the bottom queue 229 has space to accommodate the accessed instructions. If there is room in the bottom queue 229, the instructions will be elaborated in elaborate circuit 232 and placed in the bottom queue 229 without first entering the top queue 228. However, if there is no room in the bottom queue 229, the original accessed instructions, without elaboration, are written into the top queue 228 and the elaboration process is deferred until there is room in the bottom queue 229. When there is space available in the bottom queue 229, instructions from the top queue 228 are elaborated and moved to the bottom queue 229. A multiplexer 231 is used to select a bypass path for instructions received from the coprocessor instruction selector 224 or to select instructions received from the top queue 228, under control of the queue and hazard control circuit 230. The queue and hazard control circuit 230, among its many features, supports processes 300 and 320 shown in FIGS. 3A and 3B respectively, and described in further detail below. Coprocessor instructions are written to the bottom queue 229 in the order the coprocessor instructions are received. Thus, by holding off the elaboration until it is needed, the top queue 228 is configured to support a native or unelaborated instruction format while the bottom queue 229 is configured to be wider than the top queue 228. Dispatching, as used herein, is defined as moving an instruction from the instruction fetch queue 208 to processor 204 or to coprocessor 206. Issuing, as used herein, is defined as sending an instruction, in a standard format, a decoded format, or an elaborated format for example, to an associated execution pipeline within processor 204 or within coprocessor 206.

An elaboration of an instruction may include, for example, widening and recoding of opcodes, rearrangement of various bit fields, such as source operand fields to be consistent across native instructions having source operand fields in different bit field locations, inclusion of enable field bits to differentiate between source operand bit fields that are used in some native instructions and not used in other native instructions, or the like. Such elaborations are advantageous for reducing decoding complexity when the elaborated instruction is issued. Use of elaborated instructions is also advantageous for dependency tracking between instructions in an out-of-order queue, such as may be used in the bottom queue 229. Another example of elaboration includes providing additional information for complex instructions, such as instructions that identify multiple source or target operands, using, for example, a start operand address and a range or a start operand address and an end operand address, or the like. Thus, the elaborated instruction format includes additional information for complex type instructions to identify a plurality of operands encoded in a compact form in the complex type instruction. Further, instructions may be formatted using the elaborate circuit 232 to have a consistent instruction format across a native instruction set architecture (ISA), such as an ISA for a vector processor, a SIMD processor, floating point instructions, or the like. For example, a first native instruction may specify three source operand fields A, B, and C, while a second native instruction may specify two source operand fields A and B. An elaborated instruction supports both the first and the second native instructions by having the three source operand fields A, B, and C with an indicator bit for at least the C operand that indicates it is used in the first native instruction but not used in the second native instruction.

The hybrid instruction queue 225, may store, for example, instructions in the top queue having a 32-bit instruction format, while the elaborated instructions stored in the bottom queue may have a greater than a 32-bit instruction format, such as a 56-bit format. Thus, the hybrid instruction queue 225 with elaboration between the top queue and the bottom queue provides a significant savings in implementation area and power utilization as compared to having both top and bottom queues or a larger capacity single queue all storing elaborated instructions.

For a coprocessor having multiple execution pipelines, such as shown in the coprocessor execution complex 226, the coprocessor instructions are read in-order with respect to their target execution pipelines, but may be out-of-order across the target execution pipelines. For example, CX instructions may be executed in-order with respect to other CX instructions, but may be executed out-of-order with respect to CL and CS instructions. In another embodiment, the execution pipelines may individually be configured to be out-of-order. For example, a CX instruction may be executed out-of-order with other CX instructions. However, additional dependency tracking may be required at the execution pipeline level to provide such out-of-order execution capability. By implementing the bottom queue 229 as an OoO queue, the queue and hazard control circuit 230 may efficiently check for dependencies between instructions and control instruction issue to avoid hazards, such as dependency conflicts between instructions.

The bottom queue 229 is sized so that it is rarely the case that an instruction is kept from issuing due to its being in the in-order queue when it otherwise would have been issued if the OoO queue were larger. In an exemplary implementation, the top queue 228, as an in-order FIFO queue, and the bottom queue 229, as an out-of-order issue queue, are each implemented with sixteen entries. The top queue and the bottom queue may be of different capacities depending upon application utilization. The coprocessor execution complex 226 is configured with a coprocessor store (CS) issue pipeline 236 coupled to a CS execution pipeline 237, a coprocessor load (CL) issue pipeline 238 coupled to a CL execution pipeline 239, and a coprocessor function (CX) issue pipeline 240 coupled to a CX execution pipeline 241. Also, a coprocessor register file (CRF) 242 may be coupled to each execution pipeline. The capacity of the in-order queue 228 may also be matched to support the number of instructions the processor 204 is capable of sending to the coprocessor 206. In this manner, a burst capability of the processor 204 to send coprocessor instructions may be better balanced with a burst capability to drain coprocessor execution pipelines. By having a sufficient number of instructions enqueued, the coprocessor 206 would not be starved when instructions are rapidly drained from the hybrid instruction queue 225 and the processor 204 is unable to quickly replenish the queue.

FIG. 2B illustrates an encoded format 250 of a generic native instruction. The encoded format 250 is a 32-bit format having multiple bit fields that identify the function and parameters required for execution. It is noted that the encoded format 250 is representative only and embodiments of the invention are not limited to particular formats and locations of bit fields in a particular format. Many processors, such as ARM, Power, MIPS and the like utilize different 32-bit instruction formats and may utilize reduced 16-bit and expanded 64-bit formats which may also be suitable to be elaborated as described in further detail below.

The encoded format 250 uses an opcode-1 (Opc1) 252 and an opcode-2 (Opc2) 253 to identify the function represented by a particular encoded instruction. Some architectures, such as those used by ARM processors include a conditional execution (cond) 254 to identify conditions for execution. A exemplary vector multiply instruction may be encoded using the encoded format 250 which uses multiple bit fields, N 255 concatenated with Vn 256 to identify a first set of operands and M 257 concatenated with Vm 258 to identify a second set of operands. A result destination is identified by D 259 concatenated with Vd 260. A bit field size (sz) 261 identifies a data type, such as sz=00 for single precision data elements and operations and sz=01 for double precision data elements and operations. A bit field Q 262 may be used to identify a double word operation when not asserted and a quad word operation when asserted. Additional bit fields P 263 and U 264 are utilized to convey additional information regarding the encoded operation.

FIG. 2C illustrates an elaborated format 275 of the generic native instruction of FIG. 2B in accordance with an embodiment of the present invention. In the elaborated format 275, source operands and destination results may be rearranged to be consistent across the set of coprocessor instructions. For example, N 255 in bit 5 and Vn 256 in bits 12-15 of FIG. 2B may be relocated to N 284 in bit 26 and Vn 283 in bits 22-25, respectively. Similarly, M 257 in bit 7 and Vm 258 in bits 0-3 of FIG. 2B may be relocated to M 280 in bit 13 and Vm 279 in bits 9-12, respectively. Also, D 259 in bit 22 and Vd 260 in bits 8-11 of FIG. 2B may be relocated to D 288 in bit 40 and Vd 287 in bits 36-39, respectively. The sz field 261, in bits 20 and 21, is relocated to sz field 293, in bits 48 and 49. The Q field 262, in bit 6, the P field, in bit 4, and the U field 291, in bit 46, are relocated to Q field 292, in bit 47, P field 290, in bit 45, and U field 291, bit 46, respectively.

Certain bit fields may be expanded in definition requiring a wider bit field and relocated in an elaborated format. An example of widening and recoding of bit fields includes expanding opcode and opcode type fields from the initial encoding into a major, a minor, and opcode fields in an elaborated encoding. The elaborated encoding may then provide a quick determination of coprocessor encodings and general processor encodings. For example, vector floating point instructions for execution on a coprocessor may be identified with a separate bit, such as a V bit 295 in FIG. 2C. Minor 294 and opcode (Opc1) 289 fields may then be included in the elaborated format 275 for specific instruction identification. A major bit field may be used to provide an identification to quickly distinguish between a processor instruction and a coprocessor instruction. For such a purpose, the indication may be generated in a predecoder and stored with the instruction in an instruction cache, such as included in the L1 instruction cache and predecoder complex 210. Once coprocessor instructions are selected from the instruction fetch queue 208, the major bit field may not be required within the coprocessor 206 and thus be excluded from an elaborated instruction to minimize the size (width) of the elaborated encoding.

Another example of widening and recoding is to expand register specification bit fields into a start address bit field and end address bit field to cover a range of selectable register values for vector type operations. For example, a register specified by start address N 255∥Vn 256 of FIG. 2B is expanded to start address N 284, top value in bit 26,∥Vn 283∥0 296, top value in bit 21, and end address Vn+1+2Q 282, top value in bits 15-20. The 0/N 296, bottom value in bit 21, represents a case where not all the registers in the range are used, but rather registers are selected every other double word for use in the execution of the instruction. The Vn(calc) 282, bottom value in bits 15-20, represents a calculation of an address based the type of encoded instruction and may also be based on other data in the instruction. The Vn+1+2Q 282 represents an exemplary calculation based on other data in the instruction, such as the Q bit 292. For some instructions, the bit field 282 may require a different calculation. An example for Vn(calc), would be Vn+1+2*(len), where len is a bit immediate value comprised of bits {9,8}, for example, in another instruction encoding having the immediate bits {9,8}. Another example, for Vm(calc), would be VM+imm-1, where imm is an 8-bit immediate value comprised of bits {0-7}, for example, of a further instruction encoding having the immediate bits {0-7}. It is noted that the exemplary immediate bit fields are representative only and embodiments of the invention are not limited to particular formats and locations of bit fields, such as immediate bit fields, in a particular format.

Such calculations are implemented in the elaborate circuit 232 of FIG. 2A. Also, some instructions may not functionally require a register specified by the Vn bit fields 284, 283, 296, and 282. In such an instruction, an enable bit En 281 in bit 14 is not asserted. Alternatively, the enable bit 281 is asserted for those instructions which utilize such Vn bit fields.

A second register may be specified by Vm bit fields M 280, top value in bit 13∥Vm 279∥0 297, top value in bit 8, and Vm+1+2Q 278, top value in bits 2-7, similar in definition to the Vn bit fields N 284, Vn 283, 0 296, and Vn+1+2Q 282, respectively. Such a register specified by the Vm bit fields may be uses as a source operand in some instructions and as a result destination in other instructions. To identify, such use, enable bits Em 277 may be utilized. For example, Em 277 may be set to “01” to identify the second register is a source operand, may be set to “10” to identify the second register is a destination result, and may be set to “00” to indicate the second register is not required by an instruction. Em 277 set to “11” is held in reserve for alternative uses. The Vm(calc) 278, bottom value in bits 2-7, represents a calculation of an address based on the type of encoded instruction and may also be based on other data in the instruction.

A third register may be specified by Vd bit fields D 288, top value in bit 40∥Vd 287∥0 298, top value in bit 35, Vd+1+2Q 286, top value in bits 29-34, and Ed 285 similar in definition to the Vm bit fields M 280, Vm 279, 0 297, Vm+1+2Q 278, and Em 277, respectively. The Vd(calc) 286, bottom value in bits 29-34, represents a calculation of an address based on the type of encoded instruction and may also be based on other data in the instruction.

FIG. 3A illustrates a process 300 for instruction elaboration in accordance with the present invention. The process 300 follows instruction operations in the coprocessor 206. References to previous figures are made to emphasize and make clear implementation details, and not as limiting the process to those specific details. At block 302, a fetch queue, such as instruction fetch queue 208 of FIG. 2A, is monitored for a first type of instruction, such as a coprocessor instruction. At decision block 304, a determination is made whether an instruction has been received from the fetch queue. If an instruction has not been received, the process 300 returns and waits until an instruction is received. When an instruction is received, the process 300 proceeds to decision block 306. At decision block 306, a determination is made whether a bottom queue 229, such as an out-of-order queue, is full of instructions. If the bottom queue 229 is not full, the process 300 proceeds to block 310. At block 310, the received instruction is elaborated in elaborate circuit 232. At block 311, the elaborated instruction is stored in the bottom queue 229. The process 300 then returns to decision block 304 to wait till the next instruction is received.

Returning to decision block 306, if the bottom queue 229 is full, the process 300 proceeds to decision block 316. At decision block 316, a determination is made whether the top queue 228 is also full. If the top queue 228 is full, the process 300 returns to decision block 304 with the received instruction pending to wait until space becomes available in either the bottom queue 229 or in the top queue 228 or both. An issue process 320, described below, issues instructions from the bottom queue 229 which then clears space in the bottom queue 229 for instructions. Returning to decision block 316, if the top queue 228 is not full, the process 300 proceeds to block 318. At block 318, the received instruction is stored unelaborated in the top queue 228 and the process 300 returns to decision block 304 to wait till the next instruction is received.

FIG. 3B illustrates a process 320 for issuing instructions in accordance with the present invention. At block 322, the bottom queue 229 is monitored for instructions to be executed. At decision block 324, a determination is made whether the bottom queue 229 has any elaborated instruction entries. If there are no elaborated instructions to be executed in the bottom queue 229, the process 320 returns to block 322 to monitor the bottom queue 229. If there are elaborated instructions in the bottom queue 229, the process 320 proceeds to decision block 326. At decision block 326, a determination is made whether an execution pipeline is available that can accept a new elaborated instruction for execution. If all the execution pipelines are busy, the process 320 waits until an execution pipeline frees up. When an execution pipeline is available to accept a new elaborated instruction for execution, the process 320 proceeds to block 328. At block 328, an elaborated instruction, stored in the bottom queue 229, is issued avoiding hazards such as dependency conflicts between instructions, to the appropriate issue pipeline. If more than one execution pipeline is available, multiple elaborated instructions without dependencies from the bottom queue 229 may be issued out of program order across multiple separate pipelines. If multiple elaborated instructions are destined for the same execution pipeline, those elaborated instructions may remain in program order. Once an elaborated instruction or elaborated instructions are issued from the bottom queue 229, space is freed up in the bottom queue 229. New unelaborated instructions from the top queue 228 may then be elaborated in elaborate circuit 232 and stored in the bottom queue 229 in preparation for execution. The process 320 proceeds to decision block 308.

At decision block 308, if the top queue 228 has no entries, the process 300 proceeds to block 304 to await a new instruction. If the top queue 228 has one or more instruction entries, the process 300 proceeds to block 312. At block 312, the one or more instructions stored in the top queue 228 are selected and elaborated in elaborate circuit 232. At block 314, the elaborated instruction or elaborated instructions are stored in the space available in the bottom queue 229. The process 300 then returns to decision block 324 to process entries in the bottom queue.

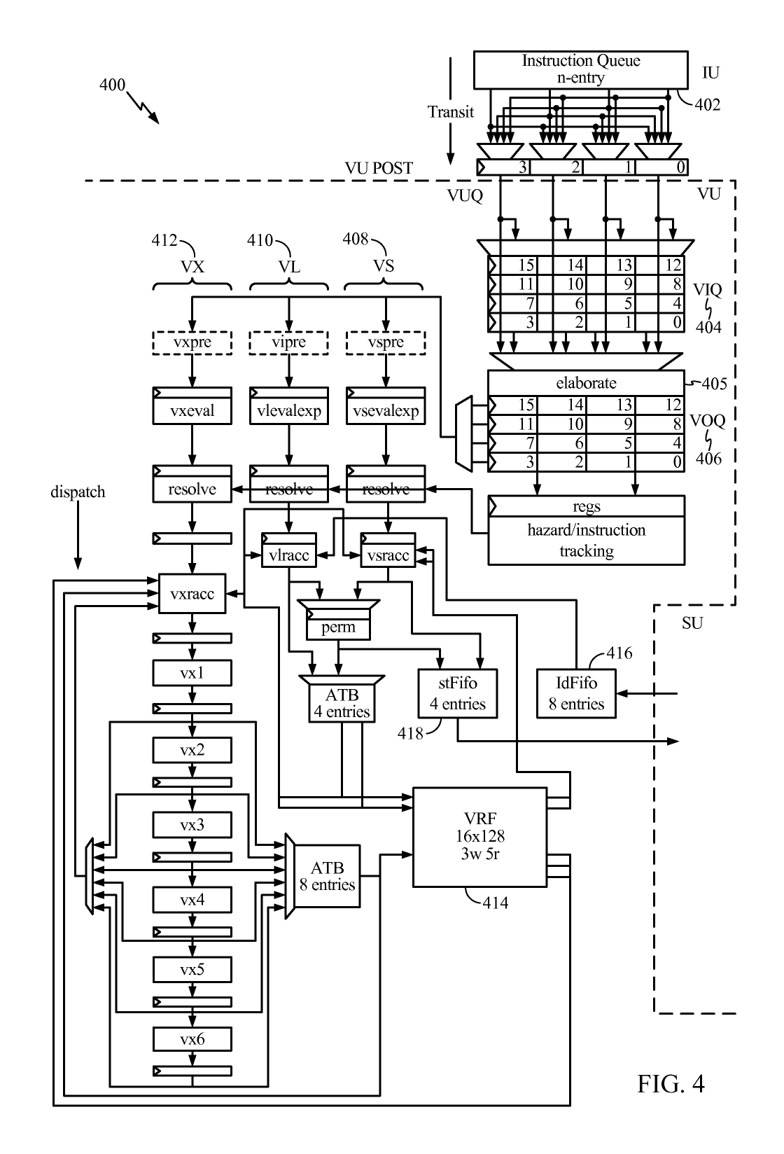

FIG. 4 illustrates an exemplary embodiment of a coprocessor and processor instruction unit (IU) and storage unit (SU) in accordance with the present invention. An n-entry instruction queue 402 corresponds to the instruction fetch queue 208. The coprocessor illustrated in FIG. 4 is a vector processor having a vector in-order queue (VIQ) 404 corresponding to in-order queue 228, an elaborate circuit 405 corresponding to elaborate circuit 232, and a vector out-of-order queue (VOQ) 406 corresponding to out-of-order queue 229. A vector store pipeline (VS) 408, a vector load pipeline (VL) 410, and a vector function execution pipeline (VX) 412 having six function computation stages (vx1-vx6). The VS, VL, and VX pipelines are coupled to a vector register file (VRF) 414 and collectively correspond to the coprocessor execution complex 226.

A load FIFO (ldFifo) 416 and a store FIFO (stFifo) 418 provide elastic buffers between the processor and the coprocessor. For example, when the coprocessor has data to be stored, the data is stored in the stFifo 418 from which the processor takes the data when the processor can complete the store operation. The ldFifo 416 operates in a similar manner but in the reverse direction.

The various illustrative logical blocks, modules, circuits, elements, or components described in connection with the embodiments disclosed herein may be implemented using an application specific integrated circuit (ASIC), a field programmable gate array (FPGA) or other programmable logic components, discrete gate or transistor logic, discrete hardware components, or any combination thereof designed to perform the functions described herein. A general purpose processor may be a microprocessor, but in the alternative, the processor may be any conventional processor, a special purpose controller, or a micro-coded controller. A system core may also be implemented as a combination of computing components, for example, a combination of a DSP and a microprocessor, a plurality of microprocessors, one or more microprocessors in conjunction with a DSP core, or any other such configuration appropriate for a desired application.

The methods described in connection with the embodiments disclosed herein may be embodied in hardware and used by software from a memory module that stores non-transitory signals executed by a processor. The software module may reside in random access memory (RAM), flash memory, read only memory (ROM), electrically programmable read only memory (EPROM), hard disk, a removable disk, tape, compact disk read only memory (CD-ROM), or any other form of storage medium known in the art. A storage medium may be coupled to the processor such that the processor can read information from, and in some cases write information to, the storage medium. The storage medium coupling to the processor may be a direct coupling integral to a circuit implementation or may utilize one or more interfaces, supporting direct accesses or data streaming using down loading techniques.

While the invention is disclosed in the context of illustrated embodiments for use in processor systems it will be recognized that a wide variety of implementations may be employed by persons of ordinary skill in the art consistent with the above discussion and the claims which follow below.

What is claimed is:

1. A method for processing instructions, the method comprising:
receiving instructions at a hybrid instruction queue;
if an out-of-order portion of the hybrid instruction queue has available space, elaborating the instructions and storing the elaborated instructions in the out-of-order portion; and
if the out-of-order portion does not have available space, storing the instructions in unelaborated form in a first queue.

2. The method of claim 1, wherein the elaborated instructions have a consistent instruction format.

3. The method of claim 1, further comprising:
issuing the elaborated instruction from the out-of-order portion to a coupled execution pipeline.

4. The method of claim 1, wherein the first queue is an in-order queue.

5. The method of claim 1, wherein a format of an elaborated instruction includes recoded opcodes.

6. The method of claim 1, wherein a format of an elaborated instruction includes rearranged source operand fields to be consistent across the instructions having source operand fields in different bit field locations.

7. The method of claim 1, wherein a format of an elaborated instruction includes enable field bits to enable a bit field used in one type of instruction and to disable the bit field not used in a different type of instruction.

8. The method of claim 1, wherein a format of an elaborated instruction includes additional information for complex instructions to identify a plurality of operands encoded in a compact form in the complex instructions.

9. The method of claim 1, wherein the elaborating further comprises:
including in the elaborated instructions a start address of a block of data for one of the received instructions; and
calculating an end address for the block of data based on information included in the received instruction, wherein the calculated end address is included in the elaborated instruction.

10. An apparatus for processing instructions, the apparatus comprising:
an elaborate circuit configured to recode instructions accessed from an instruction queue to form elaborated instructions; and
an issue queue configured to store the elaborated instructions from which the elaborated instructions are issued to a coupled execution pipeline.

11. The apparatus of claim 10, wherein the instruction queue is configured to store the instructions for a first processor inter-mixed with a different class of instructions for a second processor.

12. The apparatus of claim 10, further comprising:
a first queue configured to store the instructions when space is not available in the issue queue.

13. The apparatus of claim 12, wherein the elaborate circuit is coupled to the first queue and is configured to recode the instructions stored in the first queue to form the elaborated instructions when space becomes available in the issue queue.

14. The apparatus of claim 10, wherein the first queue and the issue queue comprise a segmented queue.

15. A method for processing instructions, the method comprising:
receiving an instruction at a hybrid instruction queue comprised of a first queue and a second queue;
when the second queue has available space, elaborating the instruction to expand one or more bit fields to reduce decoding complexity when the elaborated instruction is issued, wherein the elaborated instruction is stored in the second queue; and
when the second queue does not have available space, storing the instruction in an unelaborated form in a first queue.

16. The method of claim 15, wherein the first queue is an in-order queue.

17. The method of claim 15, wherein the second queue is an out-of-order queue.

18. The method of claim 15, wherein the elaborated instruction includes a bit field to identify whether a register address is a source operand address or a destination result address.

19. A method for processing instructions, the method comprising:
means for receiving instructions at a hybrid instruction queue, wherein the hybrid instruction queue comprises a first queue and an out-of-order queue;
means for elaborating the instructions and storing the elaborated instructions in the out-of-order queue if space is available in the out-of-order queue; and
means for storing the instructions in unelaborated form in a first queue if space is not available in the out-of-order queue.

20. A computer readable non-transitory medium encoded with computer readable program data and code, the program data and code when executed operable to:
receive an instruction at a hybrid instruction queue comprised of a first queue and a second queue;
when the second queue has available space, elaborate the instruction to expand one or more bit fields to reduce decoding complexity when the elaborated instruction is issued, wherein the elaborated instruction is stored in the second queue; and
when the second queue does not have available space, store the instruction in unelaborated form in a first queue.
